(19) United States
(12) Patent Application Publication
(10) Pub. No.: US 2018/0171153 A1
(43) Pub. Date: Jun. 21, 2018

(54) COMPOSITION FOR PAVEMENT MARKINGS

(71) Applicant: 3M Innovative Properties Company, St. Paul, MN (US)

(72) Inventors: HongQian BAO, Singapore (SG); Mohammad Yazid MORSIDI, Singapore (SG); Chi Ying M. LEE, Singapore (SG); Sheue W. LIM, Singapore (SG); Beng Hwee KOH, Singapore (SG)

(21) Appl. No.: 15/737,118

(22) PCT Filed: Jun. 15, 2016
(86) PCT No.: PCT/US2016/037649

§ 371 Date: Dec. 15, 2017

(30) Foreign Application Priority Data
Jun. 16, 2015 (SG) 10201504761Y

(51) Int. Cl. C09D 5/33; C09D 5/32; C09D 147/00; E01C 23/20; E01C 23/18; E01C 23/22; E01F 9/512; E01F 9/518; E01F 9/524

(52) U.S. Cl. CPC C09D 5/004; C09D 5/32; C09D 147/00; E01C 23/203; C08K 2003/265; E01C 23/22; E01F 9/512; E01F 9/518; E01F 9/524; E01C 23/18

(57) ABSTRACT

A composition comprises a thermoplastic binder, at least one optical component, and a colour correcting component. The optical component comprises retroreflecting particles. The color correcting component comprising at least one pigment and is selected to selectively absorb a wavelength of light. The thermoplastic binder and at least one optical component has a first colour and the colour correcting component has a second colour. The first colour and second colour are a complementary colour pair.

### FIELD

The present disclosure generally relates to compositions that are useful as markings, such as pavement markings.

### BACKGROUND

Pavement markings are part of a communication system for road users. In addition to signs and signals, pavement markings communicate to drivers where to position their vehicles, warn about upcoming conditions, and indicate where passing is allowed. Therefore, clear road markings are essential for safe driving, particularly during rainy conditions.

Pavement markings (e.g., paints, tapes, and individually mounted articles) guide and direct motorists and pedestrians traveling along roadways and paths. Paint was a preferred pavement marking for many years. However, modern liquid pavement marking materials offer significant advantages over paint, such as increased visibility, retroreflectance, improved durability, and temporary and/or removable marking options.

Conventional pavement markings may display decreased brightness over time due to exposure to dirt and the environment. Pavement markings are subject to continuous wear and exposure to the elements as well as road chemicals. One common problem with conventional pavement marking systems is their inability to stay white on the road. An associated danger is that a dirty pavement marking can become ineffective during daylight.

There is a therefore a need to provide a composition that overcomes, or at least ameliorates, one or more of the disadvantages described above.

### SUMMARY

In a first aspect of the present disclosure, there is provided a composition comprising a thermoplastic binder, at least one optical component, and a colour correcting component, said colour correcting component being selected to selectively absorb a wavelength of light.

Advantageously, the disclosed compositions may display a high luminance coefficient which persists even after a period of exposure.

Further advantageously, the disclosed compositions may retain whiteness even after a period of exposure has ended.

Also advantageously, the disclosed compositions may display improved nighttime visibility compared to some known compositions.

In a second aspect of the present disclosure, there is provided a pavement marking comprising a disclosed composition.

In a third aspect of the present disclosure, there is provided a traffic bearing surface, having thereon a pavement marking comprising the disclosed composition of the first aspect.

In a fourth aspect of the present disclosure, there is provided a pre-formed pavement marking comprising a substrate having thereon a coating of the disclosed composition of the first aspect.

In a fifth aspect of the present disclosure, there is provided a profiled audible pavement marking comprising a substrate having thereon a coating of the disclosed composition of the first aspect.

In a sixth aspect of the present disclosure, there is provided a method of forming a disclosed pavement marking, pre-formed pavement marking or profiled audible pavement marking, wherein the optical component(s) are dropped onto the surface of a mixture comprising a thermoplastic binder and a colour correcting component, after said mixture has been applied to said pavement, traffic bearing surface, pre-formed pavement or profiled audible pavement.

### Definitions

The following words and terms used herein shall have the meaning as indicated.

As used herein, “colour wheel” refers to an organization of colour hues around a circle that shows relationships between primary colours, secondary colours, complementary colours. In the RYB (or subtractive) colour model, the primary colours are red, yellow and blue. The three secondary colours (green, orange and purple) are created by mixing two primary colours. Another six tertiary colours are created by mixing primary and secondary colours. An example of a colour wheel is shown in FIG. 1

As used herein, the term ‘complementary colours’ or ‘opposite colours’ or ‘contrasting colours’ or “complementary colour pair” are defined as colours that are substantially opposite to each other on the colour wheel. By “substantially opposite”, it is meant that the colours may be directly opposite to each other on the colour wheel, or one or two colours adjacent. For example, a complementary colour pair may be, for example, yellow and violet, yellow and red-violet, or yellow and blue-violet.

As used herein, the term “hydrocarbon resin” refers to to a product derived from hydrocarbon feedstock. The term “hydrocarbon resin” may refer to both hydrogenated and unhydrogenated resins. The term “C5 hydrocarbon resin” refers to hydrocarbon resins with five carbons.

As used herein, the term ‘optical components’ refers to materials which have a high refractive index, for example a refractive index of equal to or more than 1.4. Optical components may include, for example, transparent microspheres (i.e., beads), optical elements, and combinations thereof. The optical components may have any desired shape, for example, a spheroidal shape. They may include retroreflective particles, or transparent beads.

The term ‘pavement’ is defined herein to include all possible transportation surfaces. Exemplary transportation surfaces are those made of, for example, pavement, asphalt, concrete, and bricks.

The term ‘pavement marking’ is defined as an arrangement or pattern on the pavement. Pavement markings can be in the form of any desired indicia including, for example, stripes, text, graphics, and other symbols.

As used herein, the term ‘filler’ refers to a material that is substantially non-reactive with the other components of the disclosed compositions. A filler may be inert or essentially inert.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. The term “about” shall relate to ±10% or ±5% or ±2% or ±1% of the value which is associated with it. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

### BRIEF DESCRIPTION OF THE DRAWINGS

The accompanying drawings illustrate disclosed embodiments and serves to explain the principles of the disclosed embodiments. It is to be understood, however, that the drawings are designed for purposes of illustration only, and not as a definition of the limits of the disclosure. The method will be better understood with reference to the detailed description when considered in conjunction with the non-limiting examples and the accompanying drawings, in which:

FIG. 1 is a depiction of a colour wheel; and

FIG. 2 shows the general mechanism of the disclosed double drop dispenser.

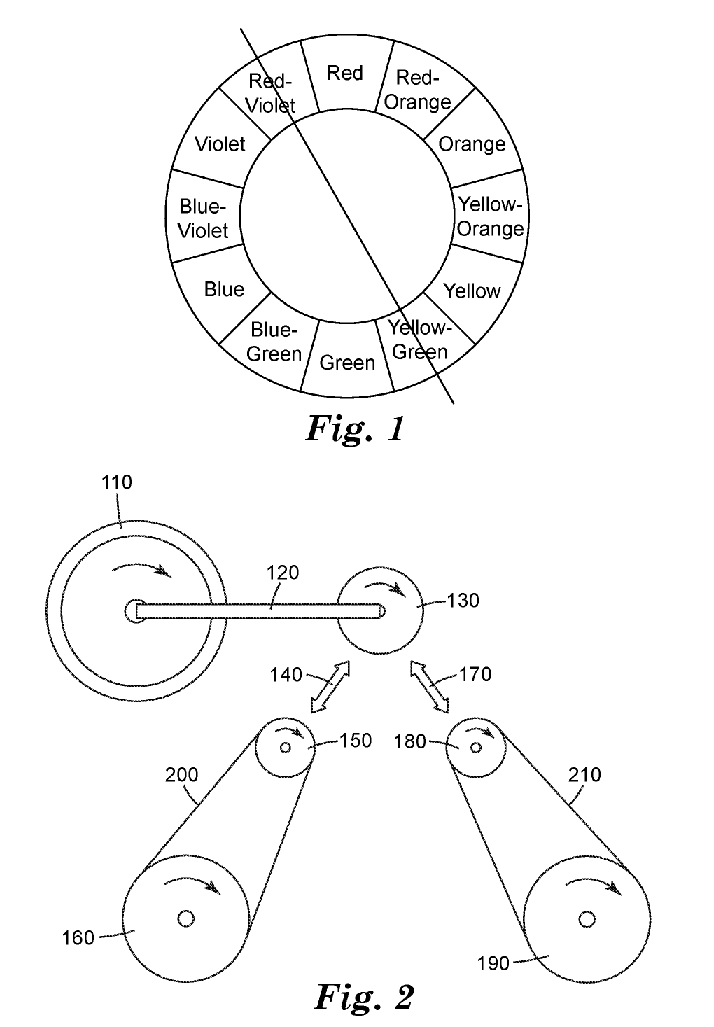

### DETAILED DESCRIPTION

There is provided a composition comprising a thermoplastic binder, at least one optical component, and a colour correcting component, said colour correcting component being selected to selectively absorb a wavelength of light.

The colour corrective component may absorb light which is of a complementary colour to an initial mixture comprising a thermoplastic binder and optical components. The addition of the colour correcting component may subtract a desired wavelength of light, thus giving the composition a desired colour.

The colour correcting component may absorb light in a range of (i) 540 to 600 nm, or (ii) 480 to 540 nm, or (iii) 445 to 505 nm. The colour correcting component, absorbing light in the range of (i) 540 to 600 nm, may therefore absorb colours which include, but are not limited to, yellow-green, yellow and yellow-orange. The colour correcting component, absorbing light in the range of (ii) 480 to 540 nm, may therefore absorb colours which include, but are not limited to, blue-green, green and yellow-green. The colour correcting component, absorbing light in the range of (iii) 445 to 505 nm, may therefore absorb colours which include, but are not limited to, violet-blue, blue and blue-green.

The disclosed composition may comprise:

(a) a mixture comprising a thermoplastic binder and at least one optical component; and
(b) a colour correcting component. The mixture (a) may have a first colour and the colour correcting component may have a second colour, wherein said first colour and said second colour may be a complementary colour pair.

The complementary colour pair may be a yellow and violet pair, a yellow and blue-violet pair, a yellow and red-violet pair, a blue and orange pair, a blue and red-orange pair, a blue and yellow-orange pair, a green and red pair, a green and red-violet pair, or a green and red-orange pair.

Colour Correcting Component

The colour correcting component may be added to the composition, for example, in the form of a whitening agent, dye particles, colourants or pigments.

Examples of useful organic pigments may include halogenated copper phthalocyanines, Benzimidazolones, Azo condensations, Arylamides, Diarylides, Disazo condensations, Isoindolinones, Isoindolines, Quinophthalones, Anthrapyrimidines, Flavanthrones, Pyrazolone oranges, Perinone oranges, Beta-naphthols, BON arylamides, Quinacridones, Perylenes, Anthraquinones, Dibromanthrones, Pyranthrones, Diketopyrrolo-pyrrole pigments (DPP), Dioxazine violets, Copper & Copper-free phthalocyanines, Indanthrones, and the like.

Examples of useful inorganic pigments may include Titanium dioxide, Zinc oxide, Zinc sulphide, Lithopone, Antimony oxide, Barium sulfate, Lead chromate, Cadmium yellow, Yellow oxides, Bismuth vanadate, Lead chromate, Lead molybdate, Cadmium red, Red iron oxide, Prussian blue, Ultramarine, Cobalt blue, Indigo, Chrome green (Brunswick green), Chromium oxide, Hydrated chromium oxide, Organic metal complexes, laked dye pigments and the like.

The pigment may be selected from the group including, but not limited to, a aluminosilicate-based pigment, cyanine-based pigment, a polymethine-based pigment, a squarylium-based pigment, a phthalocyanine-based pigment, a quinone-based pigment, an azaporphyrin-based pigment, an azo-based pigment, an azochelate-based pigment, an azlenium-based pigment, a pirillum-based pigment, a croconium-based pigment, an indoaniline chelate-based pigment, an indonaphthol chelate-based pigment, a dithiol metal complex-based pigment, a pyrromethene-based pigment, an azomethine-based pigment, a xanthene-based pigment, and an oxonol-based pigment.

The colour correcting component in the composition may comprise a pigment selected from the group including, but not limited to, UltraMarine Blue, Prussian Blue and Indigo.

Exemplary whitening agents include, for example, TiO₂, barium sulfate, and zinc oxide. In embodiments including TiO₂, the composition may include, for example, from about 0.1 wt % to about 15 wt % TiO₂. The composition may include about 0.1 to about 13 wt %, or about 0.1 to about 11 wt %, or about 0.1 to about 9 wt %, or about 0.1 to about 7 wt %, or about 0.1 to about 5 wt %, or about 0.1 to about 3 wt %, or about 0.1 to about 1 wt %, or about 0.1 to about 0.5 wt %, or about 0.5 to about 15 wt %, or about 1 to about 15 wt %, or about 3 to about 15 wt %, or about 5 to about 15 wt %, or about 7 to about 15 wt %, or about 9 to about 15 wt %, or about 11 to about 15 wt %, or about 13 to about 15 wt %, or about 0.5 to about 13 wt %, or about 1 to about 11 wt %, or about 3 to about 9 wt %, or about 5 to about 7 wt % TiO₂.

Preferably, the disclosed composition may comprise less than about 5 wt %, or less than about 4 wt %, or less than about 3 wt %, or less than about 2 wt %, or less than about 1 wt %, or less than about 0.5 wt %, or about 0.1 wt %, or about 0.05 wt % of the colour correcting component.

Thermoplastic Binder

The thermoplastic binder may be present in an amount of about 10 to 30 wt %, or in an amount of about 13 to 30 wt %, or in an amount of about 15 to 30 wt %, or in an amount of about 17 to 30 wt %, or in an amount of about 19 to 30 wt %, or in an amount of about 21 to 30 wt %, or in an amount of about 23 to 30 wt %, or in an amount of about 25 to 30 wt %, or in an amount of about 27 to 30 wt %, or in an amount of about 29 to 30 wt %, or in an amount of about 10 to 29 wt %, or in an amount of 10 to 27 wt %, or in an amount of 10 to 25 wt %, or in an amount of 10 to 23 wt %, or in an amount of 10 to 21 wt %, or in an amount of 10 to 19 wt %, or in an amount of 10 to 17 wt %, or in an amount of 10 to 15 wt %, or in an amount of 10 to 13 wt %, or in an amount of 13 to 29 wt %, or in an amount of 15 to 27 wt %, or in an amount of 17 to 25 wt %, or in an amount of 19 to 23 wt %, or about 10 wt %, or about 13 wt %, or about 15 wt %, or about 17 wt %, or about 19 wt %, or about 21 wt %, or about 23 wt %, or about 25 wt %, or about 27 wt %, or about 29 wt %, or about 30 wt %.

The thermoplastic binder may be selected from the group including, but not limited to, C5 hydrocarbon resin, a resin comprising rosin acids, a resin comprising rosin esters, a resin comprising modified rosin acids, a resin comprising modified rosin esters, and mixtures thereof.

C5 hydrocarbon resins may be produced from C5 piperylenes, which are the by-product of naphtha cracking. Liquid C5 piperylene feedstock can be polymerized to form a C5 hydrocarbon resin. It is a low polymer with the molecular weight between 300-3000 g/mol. C5 hydrocarbon resins are predominately aliphatic materials, but the structure of the resin is difficult to characterize because various isomers of the feedstock can combine unpredictably. C5 hydrocarbon resins can be hydrogenated to improve stability and other properties.

Examples of commercially available C5 hydrocarbon resins may include Quintone hydrogenated aliphatic resins such as K100 and C200H from Zeon Chemicals Co., LTD. Thailand, and EASTOTAC aliphatic resins such as H-100E and H-100R from Eastman Chemical Company, Kingsport, Tenn.

In some embodiments, the compositions may comprise one or more additional thermoplastic binders in addition to the C5 hydrocarbon resin or rosin resin. Examples of useful binders include, but are not limited to, aliphatic type petroleum resins; petroleum type hydrocarbon resins such as polybutene, coumarone resins such as coumarone-indene resin; phenol resins such as phenol-formaldehyde resin; terpene type resins such as terpene-phenol resin, polyterpene resin; synthetic polyterpene resins; aromatic hydrocarbon resins; unsaturated hydrocarbon polymers; isoprene type resins; hydrogenated hydrocarbon resins; and hydrocarbon type pressure-sensitive adhesive resins. In some embodiments, ethylene-vinyl acetate copolymers, ethylene acrylic acid copolymers, polypropylene, polyethylene and the like are preferred secondary resins.

Optical Components

The optical components may be present in an amount of about 5 to 50 wt %, or in an amount of about 5 to 45 wt %, or in an amount of about 5 to 40 wt %, or in an amount of about 5 to 35 wt %, or in an amount of about 5 to 30 wt %, or in an amount of about 5 to 25 wt %, or in an amount of about 5 to 20 wt %, or in an amount of about 5 to 15 wt %, or in an amount of about 5 to 10 wt %, or in an amount of about 10 to 50 wt %, or in an amount of about 15 to 50 wt %, or in an amount of about 20 to 50 wt %, or in an amount of about 25 to 50 wt %, or in an amount of about 30 to 50 wt %, or in an amount of about 35 to 50 wt %, or in an amount of about 40 to 50 wt %, or in an amount of about 45 to 50 wt %, or about 5 wt %, or about 10 wt %, or about 15 wt %, or about 20 wt %, or about 25 wt %, or about 30 wt %, or about 35 wt %, or about 40 wt %, or about 45 wt %, or about 50 wt %.

Exemplary optical components may include, for example, transparent microspheres (i.e., beads), optical elements, and combinations thereof. The optical components may have any desired shape, with spheroidal shapes being preferred. Exemplary transparent microspheres for use in the compositions and articles of the present application may include those having a refractive index between about 1.4 and about 2.6. Exemplary transparent microspheres may include, for example, glass beads having a refractive index between about 1.4 to about 2.26, and transparent, solid microspheres. These glass beads are generally solid, transparent, non-vitreous, ceramic spheroids having at least one metal oxide phase.

The optical components may comprise retroreflective particles. Exemplary optical components for use in the compositions and articles of the present application may include those having a refractive index between about 1.5 and about 2.4. Exemplary optical components may include aggregates (i.e., a polymer matrix with transparent spheres and/or bonded core elements dispersed therein) and bonded core elements (i.e., materials having a core and a plurality of transparent spheres adhered to the core). The retroreflective particles may be selected from the group consisting of transparent glass beads and microcrystalline ceramic beads. Further exemplary retroreflective particles of the present disclosure may also be those described in WO 2013/043884 A1, WO 2009/142859 A1 or WO 2007/059175 A1.

In one embodiment, the disclosed composition may comprise transparent glass beads and microcrystalline ceramic beads. The transparent glass beads may be present in an amount of 5 to 30 wt %, or in an amount of 5 to 25 wt %, or in an amount of 5 to 20 wt %, or in an amount of 5 to 15 wt %, or in an amount of 5 to 10 wt %, or in an amount of 10 to 30 wt %, or in an amount of 15 to 30 wt %, or in an amount of 20 to 30 wt %, or in an amount of 25 to 30 wt %, or in an amount about 5 wt %, or in an amount about 10 wt %, or in an amount about 15 wt %, or in an amount about 20 wt %, or in an amount about 25 wt %. The microcrystalline ceramic beads are present in the amount of 1 to 15 wt %, or in the amount of 1 to 10 wt %, or in the amount of 1 to 5 wt %, or in the amount of 5 to 15 wt %, or in the amount of 10 to 15 wt %.

Fillers

The disclosed composition may further comprise at least one filler. Useful fillers may include, for example, clay, talc, glass particles (e.g., frit or fibers), glass beads, metal oxide particles, silica particles, ceramic microspheres, hollow polymeric microspheres (such as those available under the trade designation EXPANCEL 551 DE from Akzo Nobel, Duluth, Ga.), hollow glass microspheres (such as those available under the trade designation K37 from 3M Co., St Paul, Minn.), carbonates, metal oxides, silicates (e.g. talc, asbestos, clays, mica), sulfates, silicon dioxide and aluminum trihydrate.

Some specific examples may include ground or light calcium carbonate (with or without a surface-treatment such as a fatty acid, resin acid, cationic surfactant, or anionic surfactant); magnesium carbonate; talc; sulfates such as barium sulfate; alumina; metals in powder form (e.g., aluminum, zinc and iron); montmorillonite, bentonite clay; kaolin clay; quartz powder; and combinations of two or more.

Preferred fillers may include inorganic solids such, for example, talc, silica, zirconia, calcium carbonate, calcium magnesium carbonate, glass or ceramic microspheres, and combinations thereof. In some embodiments, calcium carbonate may be preferred.

The filler(s) may be present in an amount in the range of 30 to 70 wt %, or in the range of 30 to 65 wt %, or in the range of 30 to 60 wt %, or in the range of 30 to 55 wt %, or in the range of 30 to 50 wt %, or in the range of 30 to 45 wt %, or in the range of 30 to 40 wt %, or in the range of 30 to 35 wt %, or in the range of 35 to 70 wt %, or in the range of 40 to 70 wt %, or in the range of 45 to 70 wt %, or in the range of 50 to 70 wt %, or in the range of 55 to 70 wt %, or in the range of 60 to 70 wt %, or in the range of 65 to 70 wt %, or in an amount about 30 wt %, or about 35 wt %, or about 40 wt %, or about 45 wt %, or about 50 wt %, or about 55 wt %, or about 60 wt %, or about 65 wt %, or about 70 wt %.

Advantageously, a high load of calcium carbonate (>40 wt %) may increase the whiteness and hardness of the pavement marking, while decreasing the material cost of thermoplastic binder.

The filler may comprise calcium carbonate particles. The calcium carbonate particles may be of different sizes.

The disclosed composition may comprise calcium carbonate particles which are present in a first size and a second size, wherein the first and second sizes are different. The first size may be a “medium” particle size, and the second size may be a “fine” particle size.

The first “medium” particle size may be in the range of about 40 to 200 μm, and the second “fine” particle size may be in the range of about 1 to 40 μm.

The “medium” particle size may be in the range of about 40 to 200 μm, or about 50 to 200 μm, or about 60 to 200 μm, or about 70 to 200 μm, or about 80 to 200 μm, or about 90 to 200 μm, or about 100 to 200 μm, or about 110 to 200 μm, or about 120 to 200 μm, or about 130 to 200 μm, or about 140 to 200 μm, or about 150 to 200 μm, or about 160 to 200 μm, or about 170 to 200 μm, or about 180 to 200 μm, or about 190 to 200 μm, or about 40 to 190 μm, or about 40 to 180 μm, or about 40 to 170 μm, or about 40 to 160 μm, or about 40 to 150 μm, or about 40 to 140 μm, or about 40 to 130 μm, or about 40 to 120 μm, or about 40 to 110 μm, or about 40 to 100 μm, or about 40 to 90 μm, or about 40 to 80 μm, or about 40 to 70 μm, or about 40 to 60 μm, or about 40 to 50 μm, or about 40 to 190 μm, or about 40 μm, or about 50 μm, or about 60 μm, or about 70 μm, or about 80 μm, or about 90 μm, or about 100 μm, or about 110 μm, or about 120 μm, or about 130 μm, or about 140 μm, or about 150 μm, or about 160 μm, or about 170 μm, or about 180 μm, or about 190 μm, or about 200 μm.

The “fine” particle size may be in the range of about 10 to 40 μm, or about 10 to 35 μm, or about 10 to 30 μm, or about 10 to 25 μm, or about 10 to 20 μm, or about 10 to 15 μm, or about 15 to 40 μm, or about 20 to 40 μm, or about 25 to 40 μm, or about 30 to 40 μm, or about 35 to 40 μm, or about 10 μm, or about 15 μm, or about 20 μm, or about 25 μm, or about 30 μm, or about 35 μm, or about 40 μm.

Advantageously, the addition of medium particle sized calcium carbonate may reduce the viscosity of hot melt while retaining its flowability.

Plasticizer

The disclosed composition may further comprise a plasticizer.

Suitable plasticizers may include, but are not necessarily limited to, dicarboxylic/tricarboxylic ester-based plasticizers, trimellitates, adipates, sebacates, maleates, bio-based plasticizers or other plasticizers.

Dicarboxylic/tricarboxylic ester-based plasticizers may include, but are not limited to, bis(2-ethylhexyl) phthalate (DEHP), diisononyl phthalate (DINP), di-n-butyl phthalate (DnBP, DBP), butyl benzyl phthalate (BBzP), diisodecyl phthalate (DIDP), dioctyl phthalate (DOP or DnOP), diisooctyl phthalate (DIOP), diethyl phthalate (DEP), diisobutyl phthalate (DIBP) and di-n-hexyl phthalate.

Trimellitates may include, but are not limited to, trimethyl trimellitate (TMTM), tri-(2-ethylhexyl) trimellitate (TEHTM-MG), tri-(n-octyl,n-decyl) trimellitate (ATM), tri-(heptyl,nonyl) trimellitate (LTM) and n-octyl trimellitate (OTM).

Adipates, sebacates, maleates may include, but are not limited to, bis(2-ethylhexyl)adipate (DEHA), dimethyl adipate (DMAD), monomethyl adipate (MMAD), dioctyl adipate (DOA), dibutyl sebacate (DBS), dibutyl maleate (DBM) and diisobutyl maleate (DIBM).

Bio-based plasticizer may include, but are not limited to, acetylated monoglycerides, alkyl citrates, triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC, trihexyl o-butyryl citrate) and trimethyl citrate (TMC).

Other plasticizers may include, but are not limited to, benzoates, terephthalates such as dioctyl terephthalate/DEHT, 1,2-cyclohexane dicarboxylic acid diisononyl ester, epoxidized vegetable oils, alkyl sulphonic acid phenyl ester (ASE), sulfonamides, N-ethyl toluene sulfonamide (o/p ETSA), ortho and para isomers, N-(2-hydroxypropyl) benzene sulfonamide (HP BSA), N-(n-butyl) benzene sulfonamide (BBSA-NBBS), organophosphates such as tricresyl phosphate (TCP) and tributyl phosphate (TBP), glycols/polyethers such as triethylene glycol dihexanoate (3G6, 3GH), tetraethylene glycol diheptanoate (4G7), polymeric plasticizers and polybutene. Examples of commercially available plasticizers may include, for example, Eastman 168 from Eastman Chemical, Kingsport, US.; Rhodiasolv IRIS from Rhodia, Bristol, US.

Processing Additives

The disclosed composition may further comprise a wax. The composition may comprise mineral oil, white oil, wax (e.g., polyethylene or polypropylene wax) and combinations of two or more to improve application properties. Natural wax like bee's wax, paraffin, carnauba wax and montan wax as well as synthetic waxes may be utilized. Those additives may typically have an average molecular weight of about 450 to 3000 g/mol. The compositions may comprise about 1 wt % to about 10 wt % of additives, or about 1 to about 8 wt %, or about 1 to about 6 wt %, or about 1 to about 4 wt %, or about 1 to about 2 wt %, or about 2 to about 10 wt %, or about 4 to about 10 wt %, or about 6 to about 10 wt %, or about 8 to about 10 wt %, or about 2 to about 8 wt %, or about 4 to about 6 wt %, or about 1 wt %, or about 2 wt %, or about 4 wt %, or about 6 wt %, or about 8 wt % or about 10 wt %.

The wax may be a polyethylene or polypropylene wax.

Viscosity Modifier

The composition may further comprise a viscosity modifier. The viscosity modifier may be bentonite clay, such as a sodium or a calcium bentonite.

### General Examples of Disclosed Compositions

The disclosed composition may comprise:
(a) a C5 hydrocarbon resin;
(b) at least one pigment;
(c) at least one optical component;
(d) a colour correcting component; and
(e) at least one filler.

The disclosed composition may comprise:
(a) a C5 hydrocarbon resin present in an amount of 10 to 30 wt %;
(b) pigment(s) present in an amount of 1 to 15 wt %;
(c) optical component(s) present in an amount of 5 to 50 wt %;
(d) a colour correcting component present in an amount less than 5 wt %; and
(e) filler(s) present in an amount of 30 to 70 wt %.

The disclosed composition may comprise:
(a) a C5 hydrocarbon resin present in an amount of 10 to 30 wt %;
(b) TiO₂ present in an amount of 1 to 15 wt %;
(c) Transparent glass beads and/or microcrystalline ceramic beads present in an amount of 5 to 50 wt %;
(d) a colour correcting component present in an amount less than 5 wt %; and
(e) Calcium carbonate present in an amount of 30 to 70 wt %.

Pavement Markings

There is provided a pavement marking comprising a disclosed composition.

There is also provided a traffic bearing surface having thereon a pavement marking comprising a disclosed composition.

There is further provided a pre-formed pavement marking comprising a substrate having thereon a coating of a disclosed composition.

The pavement marking composition may be applied to the transportation surface by any suitable means, including, for example, screed, spray, and coating on a web followed by application to a roadway.

The pavement markings can have a thickness of, for example, between about 0.5 mm and about 10 mm, between about 0.5 mm and about 9.5 mm, between about 0.5 mm and about 9.0 mm, between about 0.5 mm and about 8.5 mm, between about 0.5 mm and about 8.0 mm, between about 0.5 mm and about 7.5 mm, between about 0.5 mm and about 7.0 mm, between about 0.5 mm and about 6.5 mm, between about 0.5 mm and about 6.0 mm, between about 0.5 mm and about 5.5 mm, between about 0.5 mm and about 5.0 mm, between about 0.5 mm and about 4.5 mm, between about 0.5 mm and about 4.0 mm, between about 0.5 mm and about 3.5 mm, between about 0.5 mm and about 3 mm, between about 0.5 mm and about 2.5 mm, between about 0.5 mm and about 2 mm, between about 0.5 mm and about 1.5 mm, between about 0.5 mm and about 1 mm, between about 1 mm and about 10 mm, between about 1.5 mm and about 10 mm, between about 2 mm and about 10 mm, between about 2.5 mm and about 10 mm, between about 3.0 mm and about 10 mm, between about 3.5 mm and about 10 mm, between about 4.0 mm and about 10 mm, between about 4.5 mm and about 10 mm, between about 5.0 mm and about 10 mm, between about 5.5 mm and about 10 mm, between about 6.0 mm and about 10 mm, between about 6.5 mm and about 10 mm, between about 7.0 mm and about 10 mm, between about 7.5 mm and about 10 mm, between about 8.0 mm and about 10 mm, between about 8.5 mm and about 10 mm, between about 9.0 mm and about 10 mm, between about 9.5 mm and about 10 mm, and preferably between 1 and 2 mm.

In some embodiments, pavement markings are applied to a roadway using a pavement marking application device. This can be referred to as, for example, a hot-melt screeded process. Optical components may then be dropped to the screeded pavement marking before the material has cooled and hardened.

In some embodiments, pavement markings are applied to a roadway using a flame-spraying process. In at least some of these embodiments, the composition can be applied using commercially-available flame-spray equipment for pavement marking applications.

The pavement marking composition may also be formed into a preformed marking, wherein the binder and fillers are mixed, melted, pressed into a film, cooled, and later reheated and applied directly onto the transportation surface using a torch or other localized heating source.

The disclosed compositions may form a hot melt screeded roadway marking, a hot melt sprayed roadway marking, a hot melt hand-applied roadway marking, a preformed extruded roadway marking, an extruded roadway marking, a pavement marking paint. In some embodiments, the disclosed compositions may be heated to form a mixture. In some embodiments, the mixture may be a homogeneous mixture.

The disclosed compositions may be used to form a marked transportation surface. Transportation surfaces to which the pavement marking materials of the present application may be applied include, for example, roadways, walkways, bicycle paths, curbs, traffic barriers, barricades, steps, parking lots, and other transportation-related horizontal, inclined or vertical surfaces.

In an additional embodiment, there is provided a profiled audible pavement marking comprising a substrate having thereon a coating of the composition as described in the preceding sections. Accordingly, the pavement marking composition may be formed into a profiled audible or vibratory pavement marking which has a profile such that the leading and trailing edges of the bump are sloped at a sufficient angle to create an audible warning to drivers.

The retroreflectivity of pavement markings may provide visual guidance for drivers. Retroreflectivity diminishes as the pavement marking surface erodes (e.g., the microspheres become dislodged or are damaged). This visibility is particularly important for wet nighttime driving. Pavement markings according to the present disclosure may provide good wet night visibility and skid resistance, which is retained throughout their life span.

Double-Drop Dispenser

Conventional road marking applicators utilize a single-drop dispenser, which is suitable for normal glass beads dropping. Single-drop dispensers are unable to drop beads of different specific gravity. The reflective elements when used in the present disclosure have low specific gravity compared to glass beads which does not allow the utilization of a single-drop dispenser. Consequently, the present disclosure further relates to a double-drop dispenser system.

The double-drop dispenser system advantageously allows operators to calibrate and adjust beads' drop rates with more efficiency.

There is provided a method of forming the pavement marking, pre-formed pavement marking or profiled audible pavement marking as defined above, wherein the optical component(s) may be dropped onto the surface of the mixture comprising a thermoplastic binder and a colour correcting component; and after said mixture has been applied to said pavement, traffic bearing surface, pre-formed pavement or profiled audible pavement.

The optical components may comprise a first component and a second component, wherein the first component has a different specific gravity and/or density to the second component, and wherein the first component is dropped at a different rate to the second component.

The first component and second component may be dropped simultaneously.

The first component and second component may be dropped consecutively.

The first component and second component may be dropped sequentially.

When more than one kind of optical component is used, each type of optical component may be dropped at a different rate. Advantageously, dropping each type of optical component at a different rate may result in an even distribution of each type of optical component on the initial mixture. The resulting pavement marking may display improved nighttime visibility and whiteness retention.

The first component may be dropped at a rate of about 250 to about 500 g/m², about 250 to about 480 g/m², 250 to about 460 g/m², 250 to about 440 g/m², 250 to about 420 g/m², 250 to about 400 g/m², 250 to about 380 g/m², 250 to about 360 g/m², 250 to about 340 g/m², 250 to about 320 g/m², 250 to about 300 g/m², 250 to about 280 g/m², 250 to about 260 g/m², 260 to about 500 g/m², 280 to about 500 g/m², 300 to about 500 g/m², 320 to about 500 g/m², 340 to about 500 g/m², 360 to about 500 g/m², 380 to about 500 g/m², 400 to about 500 g/m², 420 to about 500 g/m², 440 to about 500 g/m², 460 to about 500 g/m², 480 to about 500 g/m², or about 250 g/m², 260 g/m², or about 280 g/m², or about 300 g/m², or about 320 g/m², or about 340 g/m², or about 360 g/m², or about 380 g/m², or about 400 g/m², or about 420 g/m², or about 440 g/m², or about 460 g/m², or about 480 g/m², or about 500 g/m².

The second component may dropped at a rate of about 200 to about 400 g/m², or about 200 to about 380 g/m², about 200 to about 360 g/m², about 200 to about 340 g/m², about 200 to about 320 g/m², about 200 to about 300 g/m², about 200 to about 280 g/m², about 200 to about 260 g/m², about 200 to about 240 g/m², about 200 to about 220 g/m², about 220 to about 400 g/m², about 240 to about 400 g/m², about 260 to about 400 g/m², about 280 to about 400 g/m², about 300 to about 400 g/m², about 320 to about 400 g/m², about 340 to about 400 g/m², about 360 to about 400 g/m², about 380 to about 400 g/m², or about 200 g/m², or about 200 g/m², or about 200 g/m², or about 200 g/m², or about 220 g/m², or about 240 g/m², or about 260 g/m², or about 280 g/m², or about 300 g/m², or about 320 g/m², or about 340 g/m², or about 360 g/m², or about 380 g/m², or about 400 g/m².

The first component and second component may individually be selected from the group consisting of transparent microspheres (i.e., beads), optical elements, transparent glass beads, microcrystalline ceramic beads, and combinations thereof. The first component may comprise transparent glass beads and the second component may comprise microcrystalline ceramic beads.

### EXPERIMENTAL SECTION

In these examples, all percentages, proportions and ratios are by weight unless otherwise indicated.

### Material Particulars

The materials used in the following examples are listed in Table 1 immediately below.

TABLE 1
Raw materials used in Examples

| | Trade | |
|---|---|---|
| Material Description | Designation | Supplier |
| C5 Hydrocarbon Binder | Quintone C200H | Zeon Chemicals |
| Fine Calcium Carbonate | CSI-M250 | Zhejiang Longhua |
| | | Chemical |
| Medium Calcium Carbonate | CSI-M1000 | Zhejiang Longhua |
| | | Chemical |
| Polyethylene Wax | Epolene C16 | Westlake Chemical |
| White Mineral Oil | MV1100F | Kesoon Fine Chemical |
| Bis(2-ethylhexyl) | DOTP 168 | Eastman Chemical |
| terephthalate | | Compnay |
| Bentonite Clay | Clayton AF | Zhejiang Camp- |
| | | Shinning |
| Titanium Dioxide | TioSTAR R-802 | Maha Chemicals |
| UltraMarine Blue | EP-62 | Nubiola |
| Glass Beads | Mega-Lux Type3 | Swarco Industries |
| White Microcrystalline | AWE-90S | 3M Company |
| Elements | | |

### Test Methods

The measurement of color chromaticity coordinates was obtained using a colour reader (Ultra Scan Pro, HunterLab) using a D65 illuminant and 2 degree observer. The machine was calibrated by a light trap and a white tile. The Example compositions were first melted using a hot plate and compressed into pallets with diameter around 50 mm and thickness 5 mm before cooling down. The side of the sample pallet with a smooth surface was placed facing the reader and the clamp was folded to secure the sample to the reader. The value of whiteness index were obtained using a portable whiteness meter (CR-14, Konica Minoltu Sensing, Inc.) complying with ASTM E313.

To evaluate the road performances of the disclosed pavement compositions, the measurement of coefficient of retro-reflected luminance (R_{L}) value was obtained using a portable retroreflectometer, LTL-XL (DELTA), complying with ASTM E1710. The measurement of R_{L} of road marking during wetness was in accordance with ASTM E2177. The average initial R_{L} values for road markings under wet conditions were measured approximately one week after installation. This allowed time to test whether the markings were successfully applied and whether the optical components' retention was satisfactory. The luminance coefficient (Qd) values were also obtained using portable retroreflectometer LTL-XL (DELTA). Skid resistance (SRT) was measured by portable pendulum skid resistance tester (Cooper-Wessex). The average skid resistance tester value of the road marking was maintained at a minimum value of 42 at 30° C. based on dry road surface temperature.

### Example A: General Method for Preparing Pavement Marking Compositions

Pavement marking compositions of Examples 1-15 were prepared by adding the components into high speed mixer, according to their weight ratios. The mixer was then closed and vigorously blended before getting a homogeneous mixture. The following process is used for forming pavement markings on a road according to the Examples:

a. Prior to laying of thermoplastic pavement markings, the road surface is swept clean of foreign particles like dusts, water and oil stains, and the pavement markings are set up and marked by using string and chalk powder.
b. At the same time, the raw material of thermoplastic, which is in powder form and packed in plastic packets, is poured into a preheater on a lorry to be heated until the powder melts into liquid around 150-200 degree Celsius.
c. Once the desired temperature is achieved, the thermoplastic molten is then drained from the preheated at the back of the lorry into the application machine. The machine is fixed with the shoe of the required width of the pavement marking to be laid before it is pushed manually to the site where markings are to be screeded.
d. The material inside the laying machine is drained into the shoe which is at the side of the machine. Once the shoe is almost full, the machine is pushed and the material is screed onto the road surface.
e. Retroreflective microcrystalline elements and glass beads are then dropped evenly and sequentially onto the newly laid hot thermoplastic via the double-drop dispenser located right behind the shoe as the machine is moving.

### Examples 1 to 8

Examples 1-8 (shown in Table 2) were formulated based on a C5 hydrocarbon resin. Briefly, the examples relate to a blend comprising (a) a binder comprising (i) C-5 hydrocarbon resin (10-30 wt %), (b) PE wax and DOTP 168, as lubricant and plasticizer (0.1-10 wt %), (c) high loading of calcium carbonate (40-70 wt %) which can increase the whiteness and hardness of pavement marking while decreasing overall thermoplastic cost, (d) titanium dioxide white pigment (1-15 wt %), (d) whiteness corrective (eg. UltraMarine blue, Prussian blue, indigo) (0-1 wt %), (e) transparent glass beads (5-30 wt %), and (f) white microcrystalline elements (1-10 wt %).

TABLE 2
Composition of Examples 1-8

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Components | (wt %) | (wt %) | (wt %) | (wt %) | (wt %) | (wt %) | (wt %) | (wt %) |
| C5 Hydrocarbon Resin | 18 | 18 | 18 | 18 | 18 | 18 | 18 | 18 |
| Fine Calcium Carbonate | 52 | 47 | 54 | 52 | 47 | 54 | 52 | 47 |
| Polyethylene Wax | 3 | 3 | 3 | 3 | 3 | 3 | 3 | 3 |
| Bis(2-ethylhexyl) | 1 | 1 | 1 | 1 | 1 | 1 | 1 | 1 |
| terephthalate | | | | | | | | |
| Titanium Dioxide | 5 | 10 | 3 | 5 | 10 | 3 | 5 | 10 |
| UltraMarine Blue | 0 | 0 | 0.05 | 0.05 | 0.05 | 0.1 | 0.1 | 0.1 |
| Glass Beads | 15 | 15 | 15 | 15 | 15 | 15 | 15 | 15 |
| White Microcrystalline | 5 | 5 | 5 | 5 | 5 | 5 | 5 | 5 |
| Elements | | | | | | | | |

Table 3 shows the colour chromaticity coordinates and whiteness index of Examples 1-8. Basically, the addition of colour corrective (i.e. UltraMarine blue) can significantly increase the whiteness of thermoplastic while keep its chromaticity coordinates within the white box defined by EN 1871.

TABLE 3
Chromaticity coordinates and whiteness index of Examples 1-8

| Examples | x | y | Whiteness |
|---|---|---|---|
| Ex. 1 | 0.32 | 0.34 | 56.11 |
| Ex. 2 | 0.32 | 0.34 | 55.14 |
| Ex. 3 | 0.30 | 0.33 | 82.93 |
| Ex. 4 | 0.31 | 0.33 | 79.52 |
| Ex. 5 | 0.31 | 0.33 | 75.09 |
| Ex. 6 | 0.29 | 0.32 | 97.03 |
| Ex. 7 | 0.30 | 0.32 | 96.42 |
| Ex. 8 | 0.30 | 0.33 | 84.58 |

### Examples 9 to 12

Examples 9 to 12, listed in Table 4, show additional representative compositions as described in the current disclosure. Specially, these examples comprise: two kinds of calcium carbonate fillers with different particle size distribution (40-70 wt %); white oil and bentonite clay as lubricant and viscosity modifier (0.1-10 wt %). The addition of medium particle-sized calcium carbonate and bentonite clay could reduce the viscosity of hot melt while keeping its flowability.

TABLE 4
Composition of Examples 9-12

| | Ex. 9 | Ex. 10 | Ex. 11 | Ex. 12 |
|---|---|---|---|---|
| Components | (wt %) | (wt %) | (wt %) | (wt %) |
| C5 Hydrocarbon Resin | 18 | 14.6 | 18 | 18 |
| Fine Calcium Carbonate | 25 | 26 | 25 | 25 |
| Medium Calcium Carbonate | 41.6 | 43.3 | 41.6 | 31.5 |
| Polyethylene Wax | 1 | 1 | 1 | 1 |
| White Mineral Oil | 1.2 | 1.2 | 1.2 | 1.2 |
| Bentonite Clay | 0.2 | 0.2 | 0.2 | 0.2 |
| Titanium Dioxide | 3 | 3.1 | 3 | 3 |
| UltraMarine Blue | 0.08 | 0.08 | 0.08 | 0.08 |
| Glass Beads | 5 | 7.3 | 7 | 15 |
| White Microcrystalline Elements | 5 | 3.1 | 3 | 5 |

### Example B: Double-Drop Beads Dispenser System

FIG. 2 shows the general mechanism of the disclosed double-drop bead dispenser system. FIG. 2 shows a synchronous shaft 120 connected with applicator wheel 110, top gears 150 180 connected with synchronous shaft 120, and bottom gears 160 190 connected with beads' dispensing rollers (not shown).
110 Applicator wheel
120 Synchronous shaft
130 Gear complex to drive double dispensers
140 Connecting chain (front) linking top gear 150 (front) to gear complex 130
170 Connecting chain (back) linking top gear 180 (back) to gear complex 130
150 Top gear (front) that drives the connecting chain 200 to the bottom gear (front) 160
160 Bottom gear (front) that drives the front bead dispenser (not shown)
200 Connecting chain between the top gear (front) 150 and the bottom gear (front) 160
180 Top gear (back) that drives the connecting chain 210 to the bottom gear (back) 190
190 Bottom gear (front) that drives the back bead dispenser (not shown)
210 Connecting chain between the top gear (back) 180 and the bottom gear (back) 190

The general mechanism of the disclosed double-drop dispenser is as follows. During travel, the applicator wheel's 110 movement provides the main driving force and first passes the beads to a synchronous shaft 120. Through the connecting chains 140 170, the synchronous movement drives the top gears 150 180 to roll. Through the connecting chains 200 210, the bottom gears 160 190 are also synchronized and roll together with the dispensing rollers, which drop the beads continuously. By changing the top/bottom pair gears, the dispensing roller's rolling speed can be adjusted, thus resulting in different drop rates of beads. An example of a set of gear pairs corresponding to various drop rates of glass beads and elements are summarized in Table A. For Swarco Type 3 glass beads, the drop rate may range may be from 250 to 500 g/m². For 3M white elements, the drop rate range may be from 200 to 400 g/m².

TABLE A
Partial calibration results of double-drop
beads dispenser with different gear pairs.

| | | | | |
|---|---|---|---|---|
| Top Gear | 30 | 26 | 26 | 26 |
| Bottom Gear | 16 | 16 | 18 | 20 |
| Swarco Type 3 Glass | 391 | 346 | 304 | 278 |
| Beads Drop Rate (g/m²) | | | | |
| Top Gear | 24 | 26 | 26 | 26 |
| Bottom Gear | 18 | 20 | 22 | 24 |
| 3M 90S Elements | 333 | 336 | 307 | 278 |
| Drop Rate (g/m²) | | | | |

Road Performance of Pavement Markings Using Double-Drop Beads Dispenser System

Road trials combining different thermoplastic compositions (Examples 12-15 and comparative Example A1) and optical beads' drop rates are listed in Tables 5a and 5b. For Swarco Type 3 glass beads, the preferable drop rate ranges from 250 to 500 g/m². For 3M microcrystalline elements, the preferable drop rate ranges from 200 to 400 g/m². Correspondingly, the performances of obtained pavement markings are shown in Table 6.

Serving as a corrective for pavement marking's yellowish tinge, blue colour corrective in the thermoplastic also can improve the whiteness retention of pavement marking. Example 12 includes 0.08 wt % UltraMarine Blue demonstrates a high performance both in brightness (dry and wet R_{L}) and whiteness (Qd). One week after parallel installation, the average Qd of Example 12 is 205 mcd/m²/lx, which is much higher than that of comparative Example A1 (Qd=161 mcd/m²/lx) with the same optical beads' drop rate.

TABLE 5a
Composition and optic's drop rates for Examples 12-15

| | Ex. 12 | Ex. 13 | Ex. 14 | Ex. 15 |
|---|---|---|---|---|
| Components | (wt %) | (wt %) | (wt %) | (wt %) |
| C5 Hydrocarbon Resin | 18 | 15 | 20 | 20 |
| Fine Calcium Carbonate | 25 | 24 | 22 | 23 |
| Medium Calcium Carbonate | 31.5 | 41.5 | 31.5 | 31.5 |
| Polyethylene Wax | 1 | 1 | 1 | 1 |
| White Mineral Oil | 1.2 | 1.2 | 1.2 | 1.2 |
| Bentonite Clay | 0.2 | 0.2 | 0.2 | 0.2 |
| Titanium Dioxide | 3 | 3 | 10 | 8 |
| UltraMarine Blue | 0.08 | 0 | 0 | 0 |
| Glass Beads | 15 | 10 | 10 | 10 |
| White Microcrystalline Elements | 5 | 4 | 4 | 5 |
| Drop Rate (g/m²) | | | | |
| Glass Beads | 391 | 391 | 391 | 325 |
| White Microcrystalline Elements | 278 | 278 | 278 | 224 |

TABLE 5b
Composition and optic's drop rates for Comparative Example A1

| | Comparative Example A1 |
|---|---|
| Components | (wt %) |
| “SYLVACOTE 4973” | 15 |
| “SYLVATAC RE 100” | 4.50 |
| “EPOLENE C-16” | 1.50 |
| “EASTMAN 168 PLASTICIZER” | 1.00 |
| “AC 5120” | 0 |
| “OMYACARB 5” | 28.00 |
| “TiO₂ R-900” | 10.00 |
| MEGA-LUX TYPE 3 GLASS SPHERES | 20.00 |
| “MEGA-LUX GLASS SPHERES” | 20.00 |
| Drop Rate (g/m²) | |
| Glass Beads | 391 |
| White Microcrystalline Elements | 278 |

TABLE 6
Road performance of comparative
Examples A1 and Examples 12-15

| | | R_{L} | R_{L} | | |
|---|---|---|---|---|---|
| Examples | Measure Time | (Dry) | (Wet) | Qd | SRT |
| Comparative | Initial | 663 | — | 208 | 55 |
| Ex. A1 | One week Later | 639 | 472 | 161 | 47 |
| Ex. 12 | Initial | 672 | — | 233 | 62 |
| | One week Later | 640 | 435 | 205 | 65 |
| Ex. 13 | Initial | 669 | — | 198 | 50 |
| | One week Later | 613 | 199 | 171 | 50 |
| Ex. 14 | Initial | 721 | — | 230 | 50 |
| | One week Later | 636 | 536 | 180 | 50 |
| Ex. 15 | Initial | 614 | — | 226 | 47 |
| | One week Later | 641 | 275 | 185 | 55 |

### APPLICATION

The compositions according to the present disclosure may have improved whiteness when used in pavement markings thereby improving their performance on the road.

The disclosed compositions may advantageously retain whiteness even after a period of exposure.

The disclosed compositions may also advantageously display improved nighttime visibility.

The disclosed method of forming the disclosed compositions using a double drop method may advantageously result in an even distribution of each type of optical component on the initial mixture. The resulting pavement marking may display improved nighttime visibility and whiteness retention.

Objects and advantages of this invention have been illustrated by the preceding examples, but the particular materials and amounts thereof recited in these examples, as well as other conditions and details, should not be construed to unduly limit this invention.

1-34. (canceled)

35. A composition comprising:
a thermoplastic binder and at least one optical component comprising retroreflective particles, and a color correcting component comprising at least one pigment, said color correcting component being selected to selectively absorb a wavelength of light,
wherein the thermoplastic binder and at least one optical component has a first color and the color correcting component has a second color, wherein said first color and said second color are a complementary color pair.

36. The composition of claim 35, wherein the color correcting component absorbs light in a range of (i) 540 to 600 nm, or (ii) 480 to 540 nm, or (iii) 445 to 505 nm.

37. The composition of claim 35, wherein the complementary color pair is selected from the group consisting of a yellow and violet pair, a green and red pair, and a blue and orange pair.

38. The composition of claim 35, wherein the color correcting component comprises at least one pigment selected from a group consisting of a aluminosilicate-based pigment, cyanine-based pigment, a polymethine-based pigment, a squarylium-based pigment, a phthalocyanine-based pigment, a quinone-based pigment, an azaporphyrin-based pigment, an azo-based pigment, an azochelate-based pigment, an azlenium-based pigment, a pirillum-based pigment, a croconium-based pigment, an indoaniline chelate-based pigment, an indonaphthol chelate-based pigment, a dithiol metal complex-based pigment, a pyrromethene-based pigment, an azomethine-based pigment, a xanthene-based pigment, and an oxonol-based pigment.

39. The composition of claim 35, wherein said composition comprises less than 5 wt % of color correcting component.

40. The composition of claim 35, wherein the thermoplastic binder is present in an amount of 10 to 30 wt %.

41. The composition of claim 35, wherein the thermoplastic binder is selected from the group consisting of C5 hydrocarbon resin, a resin comprising rosin acids, a resin comprising rosin esters, a resin comprising modified rosin acids, a resin comprising modified rosin esters, and mixtures thereof.

42. The composition of claim 35, wherein the optical components are present in an amount of 5 to 50 wt %.

43. The composition of claim 35, wherein the pigment is present in an amount in the range of 1 to 15 wt %.

44. The composition of claim 35, further comprising at least one filler.

45. The composition of claim 44, wherein the filler(s) is present in an amount in the range of 30 to 70 wt %.

46. The composition of claim 35, further comprising a viscosity modifier.

47. The composition of claim 1, wherein the composition comprises:
(a) a C5 hydrocarbon resin;
(b) at least one whitening agent;
(c) at least one optical component;
(d) a color correcting component; and
(e) at least one filler.

48. The composition of claim 35, wherein the composition comprises:
(a) a C5 hydrocarbon resin present in an amount of 10 to 30 wt %;
(b) whitening agent present in an amount of 1 to 15 wt %;
(c) optical component(s) present in an amount of 5 to 50 wt %;
(d) a color correcting component present in an amount less than 5 wt %; and
(e) filler(s) present in an amount of 30 to 70 wt %.

49. A pavement marking comprising the composition of claim 35.

50. A pavement marking comprising a substrate having thereon a coating of the composition of claim 35.

51. A method of forming a pavement marking comprising the composition of claim 35, wherein the optical component(s) are dropped on to (a) of the composition of 35 after (a) of the composition of claim 35 has been applied to a substrate.
